(19) United States
(12) Patent Application Publication
(10) Pub. No.: US 2026/0259332 A1
(43) Pub. Date: Sep. 3, 2026

(54) POSITION INFORMATION PROVIDING DEVICE, POSITION INFORMATION PROVIDING METHOD, AND NON-TRANSITORY COMPUTER-READABLE RECORDING MEDIUM STORING PROGRAM

(71) Applicant: NIPPON TELEGRAPH AND TELEPHONE CORPORATION, Tokyo (JP)

(72) Inventors: Kotaro ONO, Tokyo (JP); Kenichi KAWAMURA, Tokyo (JP); Kazuhiro TOKUNAGA, Tokyo (JP); Takeshi KUWAHARA, Tokyo (JP)

(21) Appl. No.: 18/871,297

(22) PCT Filed: Jun. 16, 2022
(86) PCT No.: PCT/JP2022/024225

§ 371 Date: Dec. 3, 2024

(51) Int. Cl. G01S 19/42; G05D 1/622; G05D 107/20

(52) U.S. Cl. CPC G01S 19/42; G05D 1/622; G05D 2107/21

(57) ABSTRACT

A position information providing device according to an aspect of the present disclosure is a position information providing device connected to a mobile object including at least a GNSS receiver through a communication network, the position information providing device including: a position-measuring unit configured to measure a current position of the mobile object based on a GNSS signal received by the GNSS receiver; a prediction unit configured to predict a future position of the mobile object based on a movement history of the mobile object and an operation plan of the mobile object; and a providing unit configured to provide, in response to a request for position information indicating a past, current, or future position of the mobile object, the requested position information to a request source.

### DESCRIPTION

### Technical Field

The present disclosure relates to a position information providing device, a position information providing method, and a program.

### Background Art

In recent years, against the backdrop of a decrease in the labor force in agricultural fields, research and demonstration experiments on automatic driving technology for agricultural machines (agricultural machinery) such as tractors and combine harvesters have been conducted (for example, NPL 1). As an elemental technology related to such automatic driving of an agricultural machine, for example, there is a technology for predicting a destination of movement based on a movement history of the agricultural machine (that is, current and past position information of the agricultural machine). In addition to this, for example, there are also a technology for estimating an NW quality at the destination, a technology for automatically reducing the speed of or stopping the agricultural machine when the NW quality at the destination is poor, and a technology for analyzing video images of cameras mounted on the agricultural machine on the edge/cloud side and notifying remote control terminals or the like of any danger if any danger exists.

### CITATION LIST

### Non Patent Literature

[NPL 1] “Achieving automatic movement of agricultural machines between fields and remote monitoring and control using robot agricultural machines, 5G, and IOWN related technology,” NTT Technology Journal, 2021.03

### SUMMARY OF THE INVENTION

### Technical Problem

However, in the past, only the movement history of an agricultural machine was used to predict a destination of the agricultural machine, and thus there was a case where a destination different from the actual position of the agricultural machine was predicted. This is because an agricultural machine generally moves according to an operation plan that takes into account planting points in a field. For this reason, the NW quality at the actual destination of the agricultural machine cannot be estimated, and as a result, it may not be possible to achieve speed control of the agricultural machine.

The present disclosure has been made in view of the above points, and an object of the present disclosure is to provide a technology that can achieve automatic driving of a mobile object that also takes an operation plan into consideration.

### Solution to the Problem

According to an aspect of the present disclosure, there is provided a position information providing device connected to a mobile object including at least a GNSS receiver through a communication network, the position information providing device including: a position-measuring unit configured to measure a current position of the mobile object based on a GNSS signal received by the GNSS receiver; a prediction unit configured to predict a future position of the mobile object based on a movement history of the mobile object and an operation plan of the mobile object; and a providing unit configured to provide, in response to a request for position information indicating a past, current, or future position of the mobile object, the requested position information to a request source.

### Advantageous Effects of the Invention

A technology is provided that can achieve automatic driving of mobile objects that also takes an operation plan into account.

### BRIEF DESCRIPTION OF THE DRAWINGS

FIG. 1 is a diagram for describing an example of a movement route of an agricultural machine in a field.

FIG. 2 is a diagram for describing an example of a predicted destination of movement and a movement route according to the related art.

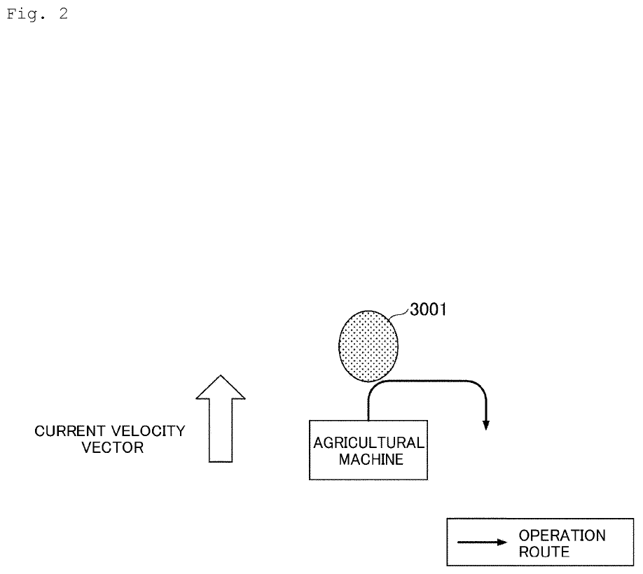

FIG. 3 is a diagram showing an example of an overall configuration of an automatic driving system according to an embodiment.

FIG. 4 is a diagram showing an example of a functional configuration of an agricultural machine according to the present embodiment.

FIG. 5 is a diagram showing an example of a functional configuration of a position information providing server according to the present embodiment.

FIG. 6 is a flowchart showing an example of operation plan data and position information data storage processing according to the present embodiment.

FIG. 7 is a flowchart showing an example of position information prediction processing according to the present embodiment.

FIG. 8 is a flowchart showing an example of position information providing processing according to the present embodiment.

### DETAILED DESCRIPTION OF THE INVENTION

An embodiment of the present invention will be described below. In the following, an automatic driving system 1 will be described which assumes that a mobile object is a movable agricultural machine (e.g., tractor, combine harvester, rice transplanter, etc.) that is mainly used for agricultural work in a field, and is capable of achieving automatic driving that also takes into consideration its operation plan. Here, the operation plan is a plan representing a route along which an agricultural machine is to be moved.

Note that the tractor, combine harvester, and rice transplanter are examples of agricultural machines, and in addition to these, agricultural robots (such as mowing robots and harvesting robots) may also be included as agricultural machines. Further, the agricultural machine does not necessarily need to be able to travel, and may be a flying agricultural machine such as an agricultural drone, for example. Furthermore, in addition to agricultural machines, for example, embodiments described below can be similarly applied to a mobile object that moves according to an operation plan in a place where lanes, drivable areas, etc. are not clearly defined.

### Movement Route of Agricultural Machine and Predicted Destination in Related Art

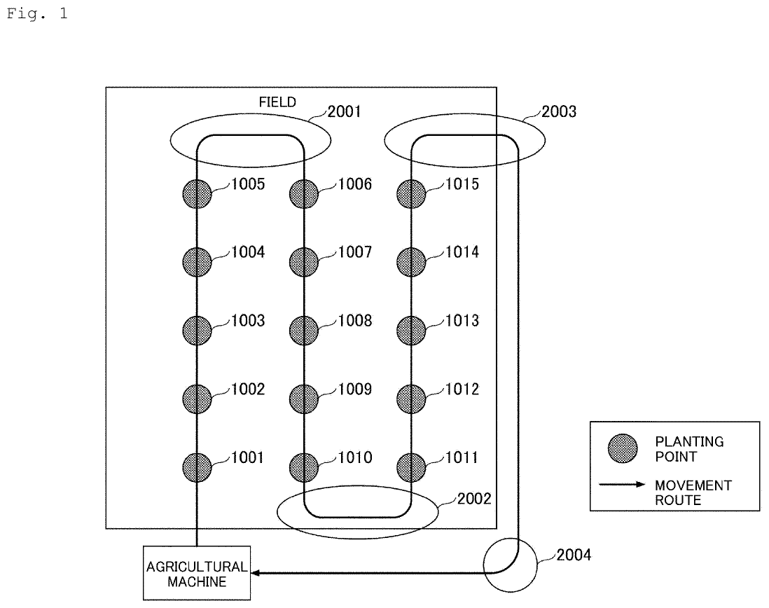

Generally, an agricultural machine moves according to an operation plan that takes into consideration the planting point (or harvesting point, etc.) in the field. For example, a case where a field has planting points arranged in a grid pattern, and an agricultural machine departs from a certain starting point, plants crops at each planting point, and then returns to the original starting point is considered. In this case, for example, as shown in FIG. 1, a conceivable operation plan of the agricultural machine is one that represents a route in which the agricultural machine passes through planting points 1001 to 1005 in order, then changes direction, thereafter, passes through planting points 1006 to 1010 in order, then changes direction again, passes through planting points 1011 to 1015 in order, exits the field, and finally returns to the starting point.

In this way, when an agricultural machine is moved according to the operation plan, there are generally direction changes on the movement route of the agricultural machine (locations indicated by reference numerals 2001 to 2004 on the movement route).

On the other hand, in the related art, the destination of the agricultural machine is predicted using only the movement history of the agricultural machine. For this reason, there is a problem in that the agricultural machine cannot cope with a sudden change in direction (in other words, a sudden change in velocity vector), and the destination of the machine may not be predicted. Note that unlike roads, where lanes and drivable areas are clearly defined, in a field, there are no lanes and the drivable areas are also not clear, and thus, even if map information, camera images, and the like are used in an auxiliary manner to predict the destination, the same problem may occur.

For example, in the case of predicting the destination immediately before the direction change indicated by reference numeral 2001, in the related art, a prediction area 3001 is predicted as an area which will be a destination at a certain time Δt ahead, using a current velocity vector calculated from current and past position information (movement history). Note that although this related art shows a case where the destination is predicted as an area, it may also be predicted as a point. On the other hand, since the agricultural machine changes direction (turns back), this prediction area 3001 cannot be predicted as the actual destination of the agricultural machine.

In this way, for example, when the target is an agricultural machine moving in a field, the prediction of the destination in the related art uses only the movement history, and thus the prediction may be incorrect due to a change in direction of the agricultural machine, etc. For this reason, the NW quality at the actual destination of the agricultural machine cannot be estimated, and as a result, it may not be possible to achieve speed control of the agricultural machine.

Note that, as an example of a technology for estimating NW quality, there is, for example, “multi-wireless quality prediction technology” described in NPL 1. Further, examples of a technology for automatically reducing the speed of or stopping an agricultural machine when the NW quality at the destination is poor include the “network cooperative device control technology” described in NPL 1 and the like. Further, examples of a technology for analyzing a video image of a camera mounted on an agricultural machine on the edge/cloud side and notifying a remote control terminal or the like of any danger if any danger exists include “data stream assist technology for enabling simultaneous use of real-time video for a plurality of applications such as remote monitoring and image analysis while reducing network load by replicating video at the monitoring base with low latency at the packet level” described in NPL 1 and the like.

In order to solve the problems in the above-mentioned related art, the automatic driving system 1 described below predicts the destination of an agricultural machine in consideration of the operation plan of the agricultural machine. This makes it possible to predict the actual destination of an agricultural machine with higher accuracy, and as a result, it becomes possible to estimate the NW quality at the actual destination of the agricultural machine and control the speed of the agricultural machine using the NW quality, making it possible to achieve safer and higher quality automatic driving.

### Example of Overall Configuration of Automatic Driving System 1

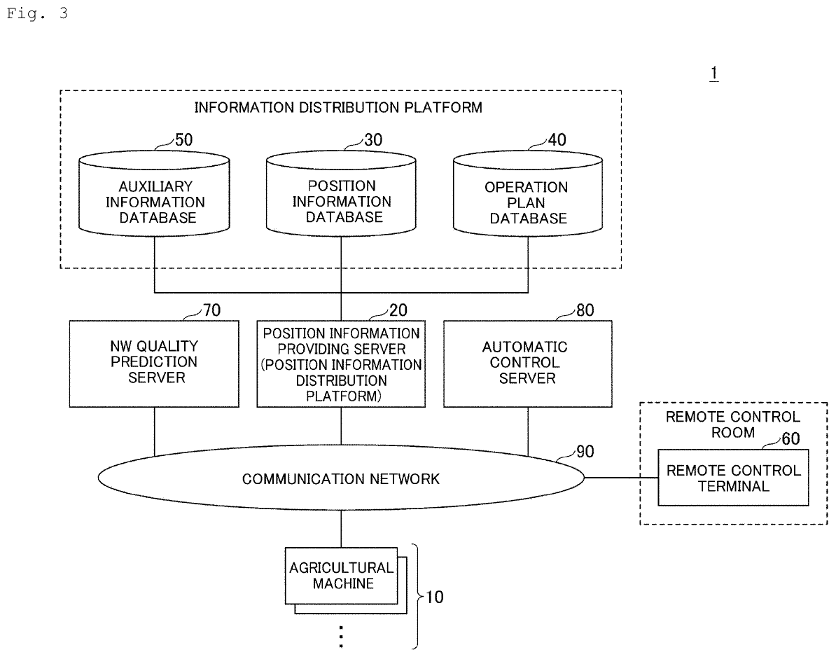

FIG. 3 shows an example of the overall configuration of the automatic driving system 1 according to the present embodiment. As shown in FIG. 3, the automatic driving system 1 according to the present embodiment includes one or more agricultural machines 10, a position information providing server 20, a position information database 30, an operation plan database 40, an auxiliary information database 50, a remote control terminal 60, an NW quality prediction server 70, and an automatic control server 80. Further, each agricultural machine 10, the position information providing server 20, the remote control terminal 60, the NW quality prediction server 70, and the automatic control server 80 are communicatively connected through a communication network 90 including, for example, the Internet. The position information providing server 20 functions as a position information distribution platform (positioning network services: PNSS) for providing position information (past, current, and future position information) of the agricultural machine 10 to other devices, systems, equipment, or the like. Further, the position information database 30, the operation plan database 40, and the auxiliary information database 50 function as an information distribution platform for managing and providing various types of information.

The agricultural machine 10 is agricultural machinery that automatically drives according to a given operation plan (in addition to moving, this also includes agricultural work such as plowing, planting, harvesting, etc.). The agricultural machine 10 includes at least a global navigation satellite system (GNSS) receiver (GNSS receiver) and a camera (capturing device or imaging device). The agricultural machine 10 can receive a signal from a GNSS satellite (GNSS signal) using a GNSS receiver. Furthermore, the agricultural machine 10 can capture images or videos of its surroundings with a camera.

Note that the agricultural machine 10 includes various sensors in addition to the GNSS receiver and the camera, and may acquire or measure various types of information using these sensors. Examples of such sensors include acceleration sensors (including 3-axis acceleration sensors), gyro sensors (including 3-axis gyro sensors), and inertial measurement units (IMUs). In the following, information acquired or measured by various sensors including cameras will be referred to as sensor information. The sensor information includes at least an image or video captured by a camera (hereinafter also referred to as a camera image or camera video).

The position information providing server 20 is a general-purpose server or the like that measures the position information of the agricultural machine 10 using GNSS signals and sensor information received from the agricultural machine 10, and predicts future position information of the agricultural machine 10 in consideration of the operation plan of the agricultural machine 10. Furthermore, in response to a request from the NW quality prediction server 70, the position information providing server 20 provides position information related to the request.

The position information database 30 is a database server that stores data including position information measured or predicted by the position information providing server 20 (hereinafter also referred to as position information data). Here, the position information database 30 stores position information data in the format (agricultural machine ID, time, position information), for example. The agricultural machine ID is identification information for identifying the agricultural machine 10. The time is information indicating the date and time when the position information was measured, or information indicating the date and time when the position information is subject to prediction (future date and time). Note that the position information data may further include, for example, information indicating whether the position information is measured or predicted.

The operation plan database 40 is a database server that stores data including operation plans of the agricultural machine 10 (hereinafter also referred to as operation plan data). Here, the operation plan database 40 stores operation plan data in the format (agricultural machine ID, operation plan), for example.

The auxiliary information database 50 is a database server that stores data including auxiliary information used for measuring and prediction of position information (hereinafter also referred to as auxiliary information data). Examples of the auxiliary information include any information that is used in an auxiliary manner for measuring or predicting position information, such as map information (2D map information, 3D map information, 4D map information, etc.), surrounding information (weather information, traffic information, accident information, construction information, etc.), calendar information (year, month, day, season, time, etc.), some event information, and the like. In addition to these, the auxiliary information may include information regarding crops that are planned to be planted or are being grown in the field (growth status of crops, planting intervals, etc.), information regarding the nature and model of the agricultural machine 10, and the like. Note that the auxiliary information database 50 stores auxiliary information data in various formats depending on the kind or type of auxiliary information.

The remote control terminal 60 is a variety of terminals used by a person (remote monitor) who monitors camera images (or camera videos) captured by a camera included in the agricultural machine 10 and controls the driving of the agricultural machine 10 as necessary. The remote control terminal 60 is installed in a facility such as a remote control room for remotely monitoring and controlling the automatic driving of the agricultural machine 10, for example. For example, according to the related art described in NPL 1, if any danger (contact, rear-end collision, etc.) exists in the agricultural machine 10, the remote control terminal 60 is notified of a warning or the like to that effect. This warning notification function may be provided by the position information providing server 20, or may be provided by a server or the like different from the position information providing server 20. Note that, as the remote control terminal 60, for example, a personal computer (PC), a smartphone, a tablet terminal, a wearable device, or the like can be used.

The NW quality prediction server 70 uses the position information provided by the position information providing server 20 to predict the NW quality at the position indicated by the position information using existing NW quality estimation technology (for example, “multi-wireless quality prediction technology” described in NPL 1).

The automatic control server 80 uses the NW quality predicted by the NW quality prediction server 70 to control the speed of the corresponding agricultural machine 10 using existing speed control technology (for example, “network cooperative device control technology” described in NPL 1. With such speed control technology, for example, when the network quality deteriorates to a level where a camera image (or camera video) captured by a camera included in the agricultural machine 10 cannot be transmitted, the agricultural machine 10 can be automatically and safely stopped. Accordingly, even when the network quality is poor and a remote monitor cannot monitor camera images, etc., the agricultural machine 10 is automatically stopped, thereby ensuring its safety.

Note that the overall configuration of the automatic driving system 1 shown in FIG. 1 is an example, and the present disclosure is not limited thereto. For example, in a case where a position-measuring method that requires a reference station (for example, real time kinematic (PTK)) position-measuring, etc.) is used when measuring the position information of the agricultural machine 10, there may be a reference station database in which data including information regarding reference stations (for example, the range of positions where the reference station is the closest reference station) is stored. In addition to the NW quality prediction server 70, there may also be a server that implements some processing or service using the position information provided by the position information providing server 20.

### Examples of Functional Configurations of Agricultural Machine 10 and Position Information Providing Server 20

Examples of functional configurations of the agricultural machine 10 and the position information providing server 20 according to the present embodiment will be described below.

### <<Agricultural Machine 10>>

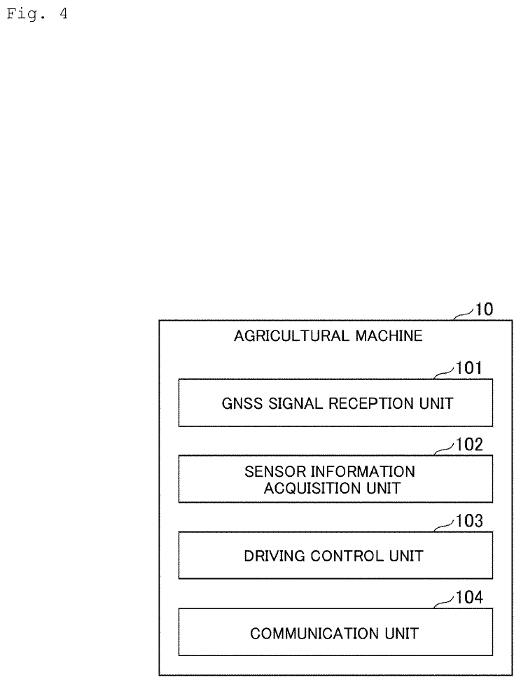

FIG. 4 shows an example of a functional configuration of the agricultural machine 10 according to the present embodiment. As shown in FIG. 4, the agricultural machine 10 according to the present embodiment includes a GNSS signal reception unit 101, a sensor information acquisition unit 102, a driving control unit 103, and a communication unit 104. Each of these functional units is implemented by, for example, one or more programs installed in the agricultural machine 10, an arithmetic device such as a central processing unit (CPU) that executes processing according to those programs, a GNSS receiver, various sensors, an interface device for connecting to the communication network 90, and the like.

The GNSS signal reception unit 101 receives GNSS signals from GNSS satellites. The sensor information acquisition unit 102 acquires sensor information (including at least a camera image or camera video) from various sensors including at least a camera. The driving control unit 103 controls the driving of the agricultural machine 10 according to a given operation plan. The operation plan is given, for example, from the remote control terminal 60 or the like. The communication unit 104 transmits the given operation plan to the position information providing server 20, and transmits the GNSS signal received by the GNSS signal reception unit 101 and the sensor information acquired by the sensor information acquisition unit 102 to the position information providing server 20. At this time, the communication unit 104 also transmits its own agricultural machine ID and the like to the position information providing server 20.

Note that the GNSS signal reception unit 101 receives the GNSS signal at a certain predetermined signal reception cycle. Similarly, the sensor information acquisition unit 102 acquires sensor information from a corresponding sensor at a certain predetermined sensing cycle.

In addition, the driving control unit 103 may detect, for example, an obstacle in front of (or around) the agricultural machine 10, and perform control to avoid the obstacle or decelerate when the obstacle is a mobile object (for example, another agricultural machine 10, etc.) .

### <<Position Information Providing Server 20>>

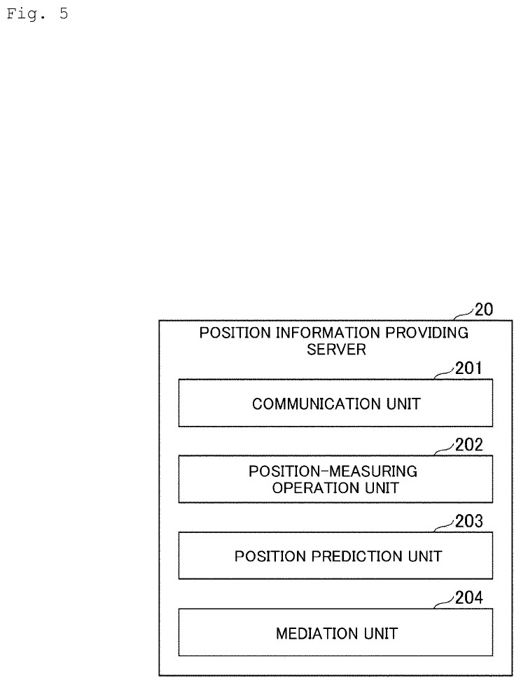

FIG. 5 shows an example of a functional configuration of the position information providing server 20 according to the present embodiment. As shown in FIG. 5, the position information providing server 20 according to the present embodiment includes a communication unit 201, a position-measuring operation unit 202, a position prediction unit 203, and a mediation unit 204. Each of these functional units is implemented by, for example, one or more programs installed in the position information providing server 20, an arithmetic device such as a CPU that executes processing according to those programs, an interface device for connecting to the communication network 90, and the like.

The communication unit 201 receives the operation plan from the agricultural machine 10, and also receives GNSS signals and sensor information. The position-measuring operation unit 202 uses the GNSS signal (or both the GNSS signal and sensor information) received by the communication unit 201 to measure the position information of the agricultural machine 10 that is the transmission source of the GNSS signal. The position prediction unit 203 uses the operation plan of the agricultural machine 10 and the movement history of the agricultural machine 10 (that is, current and past position information) to predict future position information of the agricultural machine 10. When position information is requested from the NW quality prediction server 70, the mediation unit 204 determines whether or not position information data including the position information related to the request exists in the position information database 30.

### Operation Plan Data and Position Information Data Storage Processing

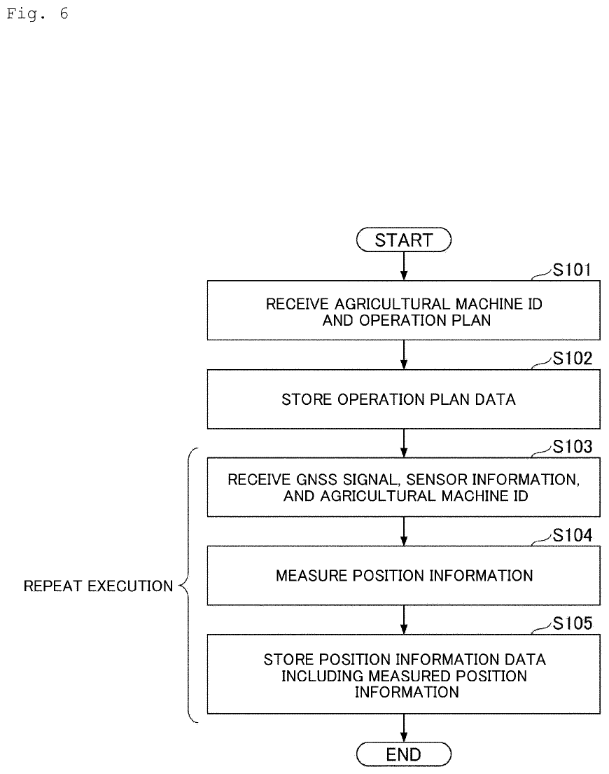

Hereinafter, processing of storing operation plan data in the operation plan database 40 and storing position information data in the position information database 30 will be described with reference to FIG. 6. Note that the following steps S103 to S105 are repeatedly executed every time a GNSS signal and sensor information are transmitted from each agricultural machine 10.

The communication unit 201 of the position information providing server 20 receives the agricultural machine ID and the operation plan from the agricultural machine 10 (step S101). Note that, when each agricultural machine 10 is given an operation plan from the remote control terminal 60, for example, it sets this operation plan to itself and transmits the operation plan and its own agricultural machine ID to the position information providing server 20.

The communication unit 201 of the position information providing server 20 stores operation plan data including the agricultural machine ID and operation plan received in step S101 above in the operation plan database 40 (step S102). Thereby, the operation plan of the agricultural machine 10 is managed in the operation plan database 40.

Note that the operation plan may be changed or updated. In this case, the agricultural machine 10 may transmit its own agricultural machine ID and the changed or updated operation plan to the position information providing server 20. Accordingly, among the operation plan data stored in the operation plan database 40, the operation plan of the operation plan data including the agricultural machine ID is updated to the changed or updated operation plan. Here, the operation plan may be changed or updated depending on various elements. For example, the operation plan may be changed or updated based on elements such as the weather, the results of the previous automatic driving according to the operation plan, the results of automatic driving of other agricultural machines 10, the results of automatic driving of a plurality of agricultural machines 10, etc. To give specific examples, for example, the operation plan may be changed or updated when the weather changes (including when the temperature changes, etc.), or the operation plan may be changed or updated when the results of the previous automatic driving according to the operation plan are not good under some evaluation index (for example, when the fuel efficiency or movement route of the agricultural machine 10 is inefficient, etc.). Alternatively, for example, when the automatic driving results of other agricultural machines 10 are not good under some evaluation index, a similar operation plan may be changed or updated, or the operation plan may be changed or updated when the automatic driving results are not good under the evaluation index representing the efficiency, safety, and the like of the plurality of agricultural machines 10 as a whole. However, these are merely examples, and in addition to these, the operation plan may be changed or updated according to the value of some evaluation index representing convenience, efficiency, economic efficiency, safety, and the like of the operation plan of one or more agricultural machines 10. In addition, the operation plan may be changed or updated not only by one element but also by a combination or weighted combination of a plurality of elements, or the operation plan may be changed or updated by prioritizing the elements. Note that changing or updating the operation plan includes, for example, changing or updating the operation plan and then restoring it to its original state.

The communication unit 201 of the position information providing server 20 receives the agricultural machine ID, GNSS signal, and sensor information from the agricultural machine 10 (step S103).

Next, the position-measuring operation unit 202 of the position information providing server 20 uses the GNSS signal (or both the GNSS signal and sensor information) received in step S103 above to measure the current position information of the agricultural machine 10 identified by the agricultural machine ID (step S104). The position-measuring operation unit 202 may measure the current position information of the agricultural machine 10 using any position-measuring method (for example, known position-measuring methods such as code position-measuring, RTK position-measuring, etc.). Further, at this time, the position-measuring operation unit 202 may achieve more accurate position-measuring by using auxiliary information data stored in the auxiliary information database 50 or by using sensor information. Examples of a technology for achieving such more accurate position-measuring include matching with map information, estimating position information using spatial information from 3D maps or 4D maps, image position-measuring by analyzing camera images or camera videos included in sensor information, dead reckoning using acceleration values and inertial measurement values included in sensor information, and estimating position information using radio wave intensity, beacons, and the like.

Then, the position-measuring operation unit 202 of the position information providing server 20 stores position information data (agricultural machine ID, time, position information) including the agricultural machine ID, the time when position-measuring was performed in step S104 above, and position information that is the position-measuring result in the position information database 30 (step S105). Accordingly, the position information data including the current time position information of the agricultural machine 10 identified by the agricultural machine ID is stored in the position information database 30.

### Position Information Prediction Processing

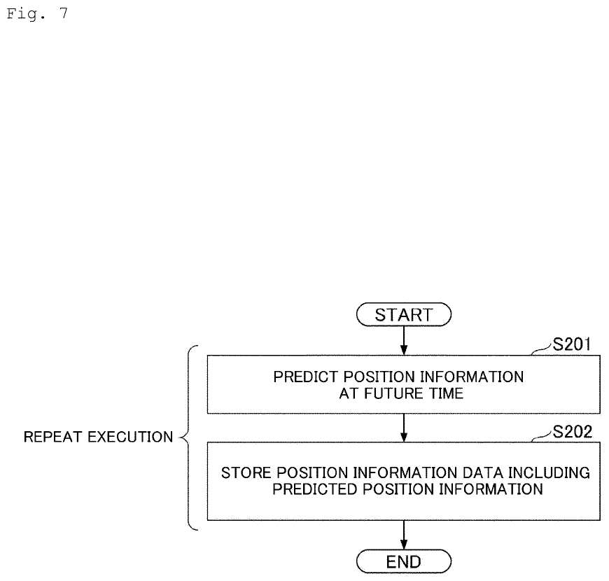

Hereinafter, processing of predicting future position information of the agricultural machine 10 identified by a certain agricultural machine ID will be described with reference to FIG. 7. Note that the following steps S201 and S202 are repeatedly executed in the background at every predetermined time interval for the agricultural machine ID, for example.

The position prediction unit 203 of the position information providing server 20 uses operation plan data including the agricultural machine ID and position information data including the agricultural machine ID to predict position information at a predetermined future time (for example, time T+Δt that is Δt seconds ahead from the current time T) (step S201). That is, the position prediction unit 203 uses the operation plan of the agricultural machine 10 with the agricultural machine ID and the position information (current and past position information) including the agricultural machine ID to predict future position information using any prediction method in consideration of the movement route of the agricultural machine 10 when it moves according to the operation plan. At this time, the position prediction unit 203 may use various types of information in addition to the operation plan and current and past position information to predict future position information. For example, the position prediction unit 203 may further use at least one piece of information such as map information (2D map information, 3D map information, 4D map information, etc.), surrounding information (weather information, traffic information, accident information, construction information, etc.), calendar information (year, month, day, season, time, etc.), event information, crop information (growth status of crops, planting intervals, etc.), and information regarding the nature and model of the agricultural machine 10, and the like to predict future position information.

Note that as the prediction method, any method can be used as long as it is capable of taking into account the movement route of the agricultural machine 10 when it moves according to the operation plan. For example, a simple method is to calculate a velocity vector at the current time from the movement history (current and past position information) of the agricultural machine 10, and then predict position information Δt seconds ahead from the value of a component of this velocity vector along the movement route.

In this manner, in step S201 described above, future position information is predicted using not only the movement history of the agricultural machine 10 but also the operation plan of the agricultural machine 10. This makes it possible to predict more accurate position information by taking into consideration the operation plan. For example, when the operation plan is changed or updated, the operation plan included in the operation plan data will also be changed or updated without delay, and thus when predicting future position information in step S201 above, the changed or updated operation plan is used.

Then, the position prediction unit 203 of the position information providing server 20 stores position information data (agricultural machine ID, time, position information) including the agricultural machine ID, the time predicted in step S201 above, and position information that is the prediction result in the position information database 30 (step S202). Accordingly, position information data including (predicted value of) position information of the agricultural machine 10 identified by the agricultural machine ID at a future time (for example, time T+Δt that is Δt seconds ahead from the current time T) is stored in the position information database 30.

### Position Information Providing Processing

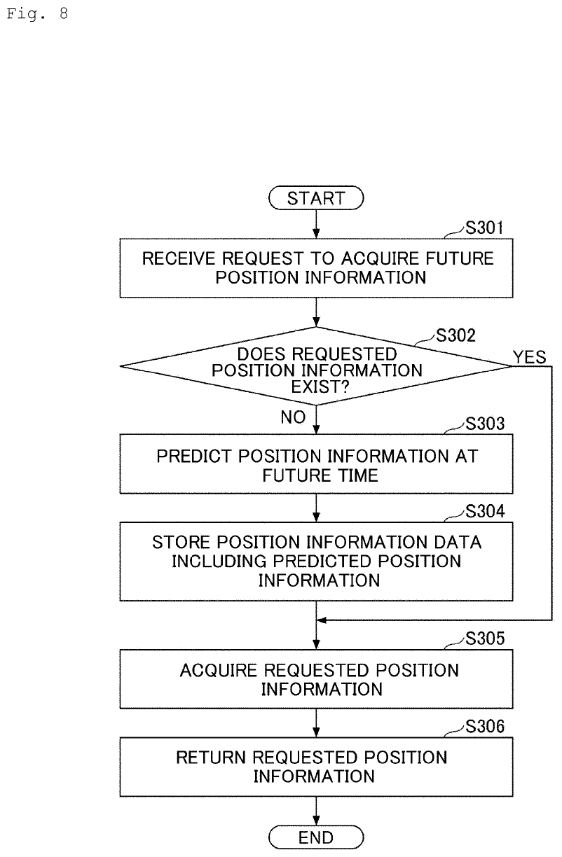

Hereinafter, processing of providing position information related to a request in response to a request from the NW quality prediction server 70 will be described with reference to FIG. 8. In the following, as an example, the NW quality prediction server 70 will be described as requesting future position information (for example, position information at time that is Δt seconds ahead from the current time) of the agricultural machine 10 identified by a certain agricultural machine ID. However, this is merely an example, and the NW quality prediction server 70 may request current or past position information. Note that the following steps S301 to S306 are executed when a request to acquire position information is transmitted from the NW quality prediction server 70 to the position information providing server 20.

The communication unit 201 of the position information providing server 20 receives a request to acquire future position information of the agricultural machine 10 identified by the agricultural machine ID (step S301).

Next, the mediation unit 204 of the position information providing server 20 determines whether or not the position information related to the acquisition request received in step S301 above (that is, the position information at time T+Δt regarding the agricultural machine 10) exists in the position information database 30 (step S302).

When it is determined in step S302 above that the position information related to the acquisition request exists, the position information providing server 20 proceeds to step S305. On the other hand, when it is not determined in the step S302 above that the position information related to the acquisition request exists, the position prediction unit 203 of the position information providing server 20 uses operation plan data including the agricultural machine ID and position information data including the agricultural machine ID as in step S201 in FIG. 7 to predict position information at time T+Δt of the agricultural machine 10 identified by the agricultural machine ID (step S303).

Next, as in step S202 in FIG. 7, the position prediction unit 203 of the position information providing server 20 stores position information data including the agricultural machine ID, the time T+Δt predicted in step S303 above, and position information that is the prediction result in the position information database 30 (step S304).

Next, the communication unit 201 of the position information providing server 20 acquires the position information related to the acquisition request (that is, the position information at time T+Δt regarding the agricultural machine 10) from the position information database 30 (step S305).

The communication unit 201 of the position information providing server 20 then returns the position information acquired in step S305 above to the NW quality prediction server 70 that is the transmission source of the acquisition request (step S306). Accordingly, the NW quality prediction server 70 can, for example, predict the NW quality of the position (or the surrounding area may be included) indicated by the position information (position information at time T+Δt regarding the agricultural machine 10) and transmit this NW quality to the automatic control server 80. Moreover, after that, the automatic control server 80 can control the speed of the corresponding agricultural machine 10 using the speed control technology using the NW quality received from the NW quality prediction server 70.

### Modification Example

### Modification Example 1

In the above embodiment, the NW quality prediction server 70 is assumed to be the providing destination of position information (future/current/past position information), but the present disclosure is not limited thereto. The target may be any server that implements some processing or service upon receiving position information from the position information providing server 20.

### Modification Example 2

In the above embodiment, it is assumed that future position information is predicted in the background (FIG. 7), but the present disclosure is not limited thereto. For example, the prediction may not be performed in the background, and the position information may be predicted each time future position information is requested from the NW quality prediction server 70.

### Modification Example 3

When predicting future position information in step S201 in FIG. 7 or step S303 in FIG. 8, after creating or predicting a movement route that avoids construction sites or accident locations based on construction information, accident information, etc., future position information may be predicted in consideration of the movement route. Further, at this time, the movement route that avoids the construction site or the accident location may be fed back to the remote control terminal 60.

### Modification Example 4

When predicting future position information in step S201 in FIG. 7 or step S303 in FIG. 8, it may be determined whether or not an obstacle exists on the movement route of the agricultural machine 10 when it moves according to the operation plan based on a camera image, a camera video, or the like, when an obstacle exists, a movement route that avoids the obstacle may be created or predicted, and then future position information may be predicted in consideration of the movement route. Further, at this time, the movement route that avoids the obstacle may be fed back to the remote control terminal 60.

### Modification Example 5

When creating or predicting a movement route that avoids obstacles in the above Modification Example 4, if some obstacle has been avoided in the past by remote control by a remote monitor, a movement route that avoids the obstacle may be created or predicted using steering information or the like at that time.

### Modification Example 6

When predicting future position information of a certain agricultural machine 10 in step S201 in FIG. 7 or step S303 in FIG. 8, future position information of other agricultural machines 10 may also be estimated at the same time by referring to the position information database 30, and when there is a likelihood that the other agricultural machines 10 will enter the movement route of the certain agricultural machine 10, future position information may be predicted in consideration of the speed deceleration (or some other avoidance operation) of the certain agricultural machine 10.

### Modification Example 7

There is a server or system that changes the harvest route (or fertilization route) in real time based on crop growth information in the field, and the operation plan may be changed or updated in real time based on this harvest route (or fertilization route). Thereby, future position information of the agricultural machine 10 can be predicted using the operation plan changed or updated in real time.

### Conclusion

As described above, in the automatic driving system 1 according to the present embodiment, when estimating future position information of the agricultural machine 10 to be automatically driven, future position information is estimated using not only the movement history of the agricultural machine 10 but also the operation plan. Thereby, future position information of the agricultural machine 10 can be estimated with higher accuracy than the related art. Therefore, for example, it is possible to provide highly accurate position information to various servers, devices, equipment, services, etc. that support or achieve automatic driving of the agricultural machine 10, and as a result, it is possible to achieve safer and higher quality automatic driving.

The present invention is not limited to the above-mentioned specifically disclosed embodiment, and various modifications and changes, combinations with known technique, and the like can be made without departing from the scope of the claims.

### REFERENCE SIGNS LIST

1 Automatic driving system
10 Agricultural machine
20 Position information providing server
30 Position information database
40 Operation plan database
50 Auxiliary information database
60 Remote control terminal
70 NW quality prediction server
80 Automatic control server
90 Communication network
101 GNSS signal reception unit
102 Sensor information acquisition unit
103 Driving control unit
104 Communication unit
201 Communication unit
202 Position-measuring operation unit
203 Position prediction unit
204 Mediation unit

1. A position information providing device connected to a mobile object including at least a GNSS receiver through a communication network, the position information providing device comprising:
a processor; and
a program installed in the position information providing device,
wherein according to the program, the processor is configured to:
measure a current position of the mobile object based on a GNSS signal received by the GNSS receiver;
predict a future position of the mobile object based on a movement history of the mobile object and an operation plan of the mobile object; and
provide, in response to a request for position information indicating a past, current, or future position of the mobile object, the requested position information to a request source.

2. The position information providing device according to claim 1, wherein according to the program, the processor is further configured to:
provide, in response to the request from a server that executes processing related to automatic driving of the mobile object, the requested position information to the server.

3. The position information providing device according to claim 1, wherein according to the program, the processor is further configured to:
predict the future position of the mobile object based further on at least one of 2D map information, 3D map information, 4D map information, weather information, traffic information, accident information, construction information, calendar information, event information, crop information in a field to which the mobile object moves, or information regarding a nature or model of the mobile object.

4. The position information providing device according to claim 1, wherein
the mobile object further includes an imaging device, and
according to the program, the processor is further configured to:
determine whether or not an obstacle exists when the mobile object moves according to the operation plan based on an image captured by the imaging device;
create or predict a movement route that avoids the obstacle when it is determined that the obstacle exists; and
predict the future position of the mobile object based on the movement history of the mobile object and the created or predicted movement route.

5. The position information providing device according to claim 3, wherein according to the program, the processor is further configured to:
when the mobile object has been remotely controlled to avoid an obstacle in the past, predict the future position of the mobile object based also on predetermined information including steering information at the time of the remote control.

6. The position information providing device according to claim 1, wherein
when the mobile object has a likelihood of a collision with another mobile object, avoidance control including deceleration control to avoid the collision is performed, and
according to the program, the processor is further configured to:
when the mobile object has a likelihood of a collision with the other mobile object, predict the future position of the mobile object based also on the avoidance control.

7. A position information providing method executed by a position information providing device connected to a mobile object including at least a GNSS receiver through a communication network, the position information providing method comprising:
measuring a current position of the mobile object based on a GNSS signal received by the GNSS receiver;
predicting a future position of the mobile object based on a movement history of the mobile object and an operation plan of the mobile object; and
providing, in response to a request for position information indicating a past, current, or future position of the mobile object, the requested position information to a request source.

8. A non-transitory computer-readable recording medium storing a program causing a position information providing device connected to a mobile object including at least a GNSS receiver through a communication network to execute:
measuring a current position of the mobile object based on a GNSS signal received by the GNSS receiver;
predicting a future position of the mobile object based on a movement history of the mobile object and an operation plan of the mobile object; and
providing, in response to a request for position information indicating a past, current, or future position of the mobile object, the requested position information to a request source.
